(19) United States
(12) Patent Application Publication
(10) Pub. No.: US 2006/0100556 A1
(43) Pub. Date: May 11, 2006

(54) Method and device to enhance skin blood flow

(76) Inventors: Alan R Hargens, San Diego, CA (US); Tanaka Kunihiko, San Diego, CA (US); James Waldie, Melbourne (AU)

Correspondence Address: JOHN S. PRATT, ESQ;KILPATRICK STOCKTON, LLP, 1100 PEACHTREE STREET, ATLANTA, GA, 30309, US

(21) Appl. No.: 10/519,262

(22) PCT Filed: Jun. 27, 2003
(86) PCT No.: PCT/US03/20430

§ 371 Date: Dec. 27, 2004

Related U.S. Application Data
(60) Provisional application No. 60/392,468, filed on Jun. 27, 2002.

(51) Int. Cl. A61H 7/00

(52) U.S. Cl. 601/11; 601/10; 601/6; 601/151

(57) ABSTRACT

A hypobaric chamber is adapted to receive the affected body part to be treated through an entry port formed in one wall of the chamber. An aperture is formed at the entry port for creating a loose, non-occlusive seal around the body part of the patient, the aperture comprising an adjustable iris formed from a pliable material attached to the edges of the entry port and having a center opening to which are attached the inner ends of a plurality of iris leaves or slides. The pliable material is stretched between the edges of the entry port and the inner ends of the slides to form a diaphragm-like structure. In the preferred embodiment, the pliable material is latex or some other rubber-like material. The seal is adjustable by moving the slides radially to adjust the portion of the port that is covered by the pliable material. The inner edges of the slides are positioned so that a small gap exists between the skin and the edge of the seal, allowing unrestricted air flow-through. The leak created by the loose seal is overcome by a high-volume pump which is connected to the chamber via appropriate vacuum tubing. The chamber pressure is reduced to create a mild negative pressure, on the order of −50 mmHg or less below ambient pressure.

### RELATED APPLICATIONS

This application claims the priority of U.S. provisional application Ser. No. 60/392,468, filed Jun. 27, 2002, the disclosure of which is incorporated herein by reference in its entirety.

Pursuant to 35 U.S.C. §202(c), it is hereby acknowledged that the U.S. Government has certain rights in the invention described herein, which was made in part with funds from the National Aeronautics and Space Administration, Grant No. NAG 9-1916.

### FIELD OF THE INVENTION

The invention relates to a method and device for enhancing skin microvascular circulation by exposure of an affected body part to a reduced pressure atmosphere. More particularly, the invention relates to a hypobaric chamber and the method for using such a chamber for enhancing circulation in a body part disposed within the chamber.

### BACKGROUND OF THE INVENTION

Patients suffering from an injury or illness that impairs blood circulation in a limb or other body part require enhancement of the circulation in order to heal, or in extreme cases, save the limb and provide for full recovery. Inadequate blood flow into and out of the injured limb can lead to such problems as pain upon exertion of the limb, slow healing of injuries, breakdown of soft tissue leading to slow healing of ulcers or even gangrene, which can lead to amputation of the affected limb.

A major source of morbidity for patients with diabetes mellitus is foot ulcers. It has been estimated that foot ulcers occur in 2.5% of diabetic patients each year. Moreover, diabetes is also the main cause of non-traumatic lower extremity amputations in orthopedics. Surgical revascularization sometimes cannot be performed for these patients due to poor peripheral circulation. Conservative treatments involving the use of dressings and other wound-care products are only adjuncts to careful local treatment, including pressure reduction for foot (crutch, wheelchair, walker), wound debridement, and infection control. Use of vasodilator drugs does not aid in the healing of diabetic foot ulcers. Hyperbaric oxygen is occasionally effective, however raising the oxygen content of the blood is of little value when the blood supply to the foot is severely impaired.

Prior art techniques have involved local application of negative pressure using chambers with powerful airtight, skintight seals to create a pressure differential between the normal ambient pressure and pressure inside the chamber. The hypobaric chamber can increase local blood flow by inducing a suction effect in the local artery, and by distending the capillaries and blood vessels to allow for the greater mass-flow rate. While such techniques may increase local blood flow, these prior art techniques often call for exposure to negative pressure over 100 mmHg, which can cause occlusion of skin, blood vessels and their flow. See, e.g., the hypobaric chamber and method of use disclosed in U.S. Pat. No. 5,423,742, which specifies a preferred pressure of 4-5 psi (˜200-250 mmHg), requiring an airtight seal between the body part and the chamber. Some studies of local blood flow and negative pressure have indicated that such tight seals over the skin compress drainage veins and actually reduce venous return.

Several prior art techniques involve an alternating positive and negative pressure cycle which attempts to simulate and/or amplify the pump effect at the treated body part. See, e.g., U.S. Pat. No. 5,000,164, in which the device is regulated according to cardiac rhythm, and U.S. Pat. No. 6,135,116 and U.S. Pat. No. 4,738,249. However, it has been determined that such cyclical techniques do not produce a stable increase in flow and, in fact, can actually decrease or, at best, provide a minor increase in blood flow in the affected body part.

Accordingly, the need remains for a device and method for effectively enhancing blood flow in a body part without subjecting the body part to conditions which counteract the beneficial effects of the treatment. The present invention is directed to such a need.

### BRIEF SUMMARY OF THE INVENTION

It is an advantage of the present invention to provide a hypobaric chamber for enhancing skin microvascular flow in which the seal is adapted to avoid occlusion of local venous drainage.

Another advantage of the present invention is to provide a method for enhancing skin microvascular flow using locally-applied negative pressure to the affected body part.

Still another advantage of the present invention is to provide a seal for a hypobaric chamber which loosely seals the affected body part, thus increasing blood flow in the skin.

In an exemplary embodiment, a hypobaric chamber is adapted to receive the affected body part to be treated through an entry port formed in one wall of the chamber. For treatment of a foot or lower leg, the port will typically be located in the top wall. For treatment of a hand or arm, the port will typically be located in a side wall, with the chamber being raised to a height that allows the patient to sit or recline comfortably during treatment. An aperture is formed at the entry port for providing a loose, non-occlusive seal around the body part of the patient, the aperture comprising an adjustable iris formed from a pliable material attached to the edges of the entry port and having a center opening to which are attached the inner ends of a plurality of iris leaves or slides. The pliable material is stretched between the edges of the entry port and the inner ends of the slides to form a diaphragm-like structure. In the preferred embodiment, the pliable material is latex or some other rubber-like material. The seal is adjustable by moving the slides radially to adjust the portion of the port that is covered by the pliable material. The inner edges of the slides are positioned so that a small gap exists between the skin and the edge of the seal. The leak created by the loose seal is overcome by a high-volume pump which is connected to the chamber via appropriate vacuum tubing. In the preferred embodiment, the chamber pressure is reduced to 10 and 20 mmHg below ambient pressure. The chamber provides for an unrestricted flow-through system, resulting in a continuous and very high local microcirculatory flow. Blood is sucked into the body part, but the treated area is so small that the shift does not unload carotid or cardiopulmonary baroceptors, and does not evoke reflexive vasoconstriction. The non-occlusive seal does not compress drainage veins, and, therefore, does not inhibit venous return. These effects result in a significant and stable increase, up to 90 times depending on the body part, in skin microvascular flow of the enclosed body part.

In a first aspect of the invention, a device for enhancing blood flow in a body part comprises a hypobaric chamber, a vacuum pump and tubing for connecting the vacuum pump to the chamber, wherein the chamber has a port formed therein for inserting at least a portion of the body part into the chamber, the port having an adjustable non-occlusive seal for encircling the body part so that the portion of the body part within the chamber is exposed to a reduced pressure relative to an ambient pressure outside of the chamber. In a preferred embodiment, the non-occlusive seal comprises an aperture formed by an iris comprising a pliable, elastic material having an outer edge attached to an entry port and a center opening to which is attached a plurality of iris slides. For use in treatment, the aperture is adjusted by moving each iris slide to stretch the pliable material radially inward, leaving a small gap between the edge of the seal and the skin surface.

In a second aspect of the invention, a method for enhancing blood flow in a body part comprises inserting the body part into a hypobaric chamber having an adjustable non-occlusive seal; adjusting the non-occlusive seal to loosely encircle the body part, and reducing the pressure within the chamber relative to an ambient pressure outside of the chamber.

### BRIEF DESCRIPTION OF THE DRAWINGS

The invention, both as to its organization and manner of operation, may be further understood by reference to the following description taken in conjunction with the following drawings wherein:

FIG. 1 is a diagrammatic view of a hypobaric chamber according to the present invention;

FIG. 2 is a diagrammatic view of a first embodiment of a non-occlusive seal according to the present invention;

FIG. 3 is a diagrammatic view of an alternate embodiment of a non-occlusive seal;

FIG. 4 is a diagrammatic view of a second alternate embodiment of a non-occlusive seal;

FIG. 5 is a diagrammatic view showing measurement points on a test subject's leg using calf and ankle seals in Example 1;

FIG. 6a is a bar graph showing normalized skin microvascular blood flow using loose seals as shown in FIG. 4 at negative pressures of −10 and −20 mmHg;

FIG. 6b is a bar graph showing normalized skin microvascular blood flow using tight seals as shown in FIG. 4 at negative pressures of −10 and −20 mmHg, according to prior art methods; and

FIG. 7 is a bar graph showing normalized skin microvascular blood flow in a diabetes mellitus patient using a non-occlusive calf seal at negative pressures of −10 and −20 mmHg.

### DETAILED DESCRIPTION OF THE PREFERRED EMBODIMENTS

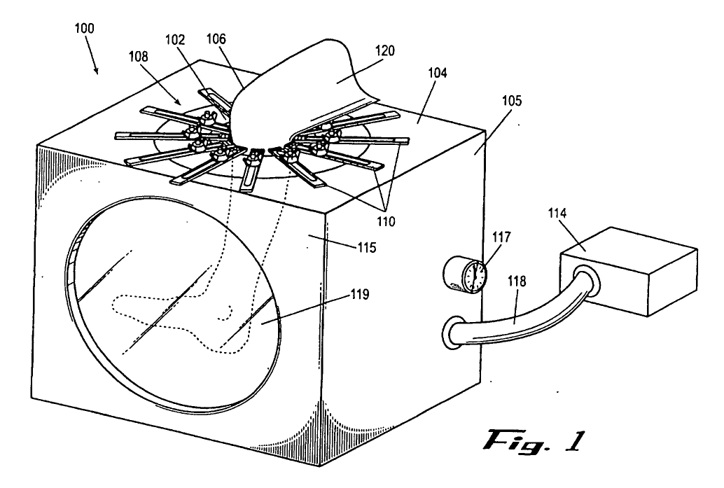

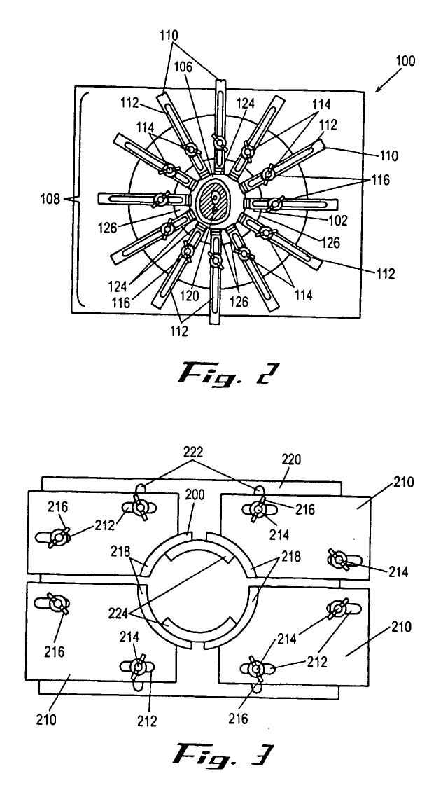

An exemplary construction of a hypobaric chamber according to the present invention is illustrated in FIGS. 1 and 2. Hypobaric chamber 100 is adapted to receive the affected body part to be treated through an entry port 102 formed in one wall of the chamber. An aperture 106 is formed at the entry port 102 for creating a loose, non-occlusive seal around the body part of the patient. The seal comprises an adjustable iris 108 formed with a sheet of pliable, elastic material 126 having a center opening which corresponds to the aperture. The outer edge of the pliable material 126 is securely fastened to the edges of the entry port to serve as a diaphragm-like structure, creating an airtight seal around the outer perimeter of the material. The edge of the opening at the center of the pliable material 126 is attached to each of a plurality of iris leaves or slides 110 which extend toward the radial center of the iris. In the preferred embodiment, the pliable material 126 is latex or other rubber-like material which is elastic and resilient and capable of forming an airtight seal at the entry port. When a slide 110 is moved inward with respect to its corresponding pin 114, the pliable material 126 to which the slide is attached will be stretched radially inward to expand the size of the seal and decrease the size of aperture 106. As each slide is adjusted, the pliable material 126 will be stretched radially inward to adjust the size of the aperture from all sides such that an airtight seal is effectively created as far inward as the edge of the opening extends. However, because the slides 110 are adjusted so that there is minimal or no contact with the skin of the individual, a small gap remains between the skin of the body part 120 and the edge of the seal so that air is allowed to flow through the gap. As illustrated in FIG. 2, the body part 120 (a lower leg) is shown in cross-section within aperture 106 with the slides 110 partially retracted for clarity. For operation, each slide 110 will be moved radially inward to stretch the pliable material 126 to reduce the diameter of the aperture, preferably without touching or applying pressure against the skin. Note that incidental contact with the patient's skin may occur at a few points around the seal, especially if the treatment duration is fairly long and the patient is unable to hold completely still. The key is to ensure that the overall seal is loose and air flow through the system is not restricted.

For treatment of a lower leg or foot, port 102 will typically be located in top 104, as shown, allowing the patient to sit next to the chamber, suspending the affected leg into port 102. Alternatively, the port can be located in a side wall 105, with the patient reclining while the leg to be treated is inserted into the chamber. A similar configuration is used for treatment of a hand or lower arm, with port 102 situated at a height adapted to allow the patient to sit or recline during treatment. The chamber may be located to position the port within a range between shoulder height and elbow height.

A preferred embodiment of the seal is illustrated in FIG. 2. In this embodiment, a plurality of radially extending slides 110 have slots 112 formed therein to permit radial movement of the slides along pins 114 which, in this case, are threaded bolts. Wing nuts 116 are used to tighten the slides in place once the desired aperture diameter is achieved. In the illustrated example, twelve slides are shown, however, more or fewer slides may be used. Each slide 110, at or near its inner edge 124, is attached to the center edge opening of a sheet of elastic, pliable material 126 such as latex, synthetic rubber or high density foam. The outer edge of the pliable material 126 is attached to the edges of the port 102 to create an airtight seal between the port and the pliable material. The pliable material 126 is, thus, stretched between each of the inner edges 124 and the edges of the port 102 so that the open area of port 102 is partially covered with an airtight seal. As a slide 110 is adjusted by sliding slot 112 along pin 114, the pliable material 126 attached to that slide is stretched or relaxed, depending on the direction of movement. Each inner edge 124 forms a segment of a twelve-faceted aperture, allowing the shape as well as the size of the aperture to be adjusted to follow the contour of the body part to form a small gap around the entire cross-section of the body part 120, creating a loose seal. The leak resulting from the loose seal is overcome by a high-volume vacuum source 122 which is connected to the chamber via appropriate vacuum tubing 118.

In the preferred embodiment, one side 115 of chamber 100 may be formed in whole or in part from a transparent material such as acrylic sheeting or Lexan® to permit visual and/or instrumental monitoring of the body part within the chamber. As illustrated in FIG. 1, visual access to the interior is provided through window 119. The shape of chamber 100 is not limited to the box configuration of the illustrated examples, but may be selected to conform generally to the shape of the body part to be treated. For example, for treatment of a lower leg, the chamber can be configured as a boot.

An alternate embodiment of the seal 200 is illustrated in FIG. 3. As shown, each leaf 210 of four upper plates has one or more slots 212 through which fasteners, in this case, threaded bolts 214, extend to permit the leaves 210 to slide inward or outward to adjust the aperture diameter around the body part to be treated. Once the desired diameter is achieved, the plates are fixed in place using wing nuts 216 disposed on the bolts 214. As in the above-described embodiment, the inner edge of each plate 210 has a pliable material 218 such as latex, rubber or high density foam disposed thereon to assist in forming the seal. As illustrated, the upper plates 210 are slidable along a horizontal line. A set of lower plates 220 is disposed underneath the upper plates to provide adjustment by way of slots 222 along an axis orthogonal to the adjustment axis of the upper plates. A pliable material 224 is disposed at the inner edge of plates 220. The combined seals of the upper and lower plate sets provide a seal that is not formed tightly around the limb, but is loose, with the aperture diameter being adjusted so that a small gap remains between the skin and the inner edges of the plates 210, 220.

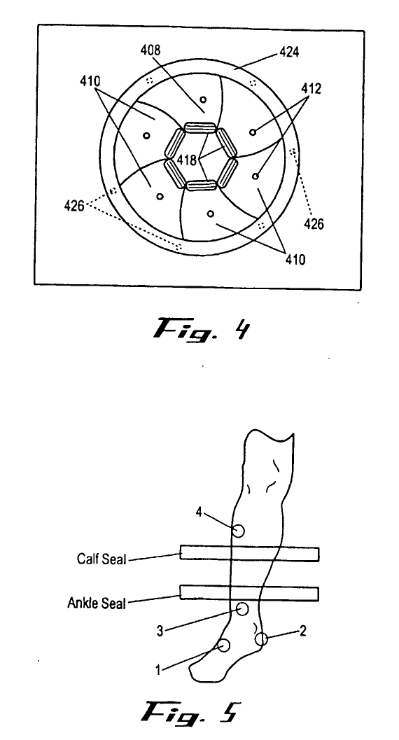

In a second alternate embodiment illustrated in FIG. 4, iris 408 has six plates or slides 410, however, more or fewer plates may be used, as will be readily apparent to those of skill in the art. Each leaf 410 pivots on a pin 412 in a configuration similar to that of apertures used for camera lenses. Once the correct aperture diameter has been determined, the iris 408 is preferably locked to maintain the selected aperture size during treatment, allowing the subject to shift his or her position without inadvertently changing the aperture size. Such locking may be achieved by fasteners such as thumb screws, wing nuts, clamps or other appropriate fastener which can be tightened onto the individual iris leaves once each has been adjusted. Alternatively, the iris leaves 410 can be simultaneously controlled by turning a control ring 424 which is pivotally linked to control pins 426 extending from each iris slide 410. When control ring 424 is rotated, each iris leaf 410 pivots inward or outward, depending on the direction of rotation, causing the aperture 406 to expand or contract. Ring 424 can then be fixed in the desired position using a thumb screw or similar fastener. Ring 424 can also be motor controlled allowing for automated or semi-automated operation of the device. As in the previously-described embodiments, a pliable material 418 is disposed on the inner edge of each slide.

Other types of mechanical irises, including manually and electromagnetically-driven irises, are known to those of skill in the art and may be adapted to achieve the non-occlusive seal of the present invention. Accordingly, the descriptions provided herein of means for achieving the non-occlusive seal are exemplary only and are not intended to be limiting with regard to the scope of the present invention.

Referring again to FIG. 1, for operation after positioning of the body part in the chamber and adjustment of the seal, the conventional commercially-available vacuum source 122 is activated to produce a mild negative pressure within the chamber. A pressure gauge 117 is provided to permit monitoring and control of the negative pressure within the chamber. Generally, the desired mild negative pressure will be between ambient pressure and about −50 mmHg. In the preferred embodiment, the chamber pressure is reduced to a range on the order of 10 to 20 mmHg below ambient pressure. The body part to be treated is held within the chamber for a pre-determined duration, which may be based on passage of time or on achieving a desired measured value, or a combination of the two. The duration of treatment may be a pre-determined period of time, or may be based upon instrumental monitoring of the patient during treatment and terminated upon achieving a pre-determined value of a relevant parameter. In the examples described below, while the duration of exposure was 5 minutes, it is believed that such a short exposure is insufficient for patients within impaired microcirculation, and an appropriate exposure would be more on the order of several hours, as indicated by the patient's condition. A significant advantage of the present invention is that, due to the relatively low vacuum pressure that is used, edema does not occur as easily as with high vacuum pressures as in prior art systems. Thus, treatments can last for several hours without detrimental swelling of the exposed limb. Repeated exposures during a single treatment session may also be desirable.

The chamber provides an unrestricted flow-through system, resulting in a continuous and very high local microcirculatory flow. Blood is sucked into the body part, but the treated area is so small that the shift does not unload carotid or cardiopulmonary baroceptors, and does not evoke reflexive vasoconstriction. The non-occlusive seal does not compress drainage veins, and, therefore, does not inhibit venous return. These effects result in a significant and stable increase, up to 90 times depending on the body part, in skin microvascular flow of the enclosed body part.

The following descriptions provide examples of applications of the hypobaric chamber according to the present invention. As will be apparent to those of skill in the art, the hypobaric chamber with non-occlusive seal can be used for other applications in treatment of diminished circulation in body parts resulting from a wide range of diseases or injuries. Other medical conditions may also benefit from the use of the inventive device and method including, but not limited to, alopecia (see, e.g., U.S. Pat. No. 5,228,431), frostbite, bums, and therapy following skin grafts or reattachment of severed limbs or digits.

### EXAMPLE 1

### Lower Leg

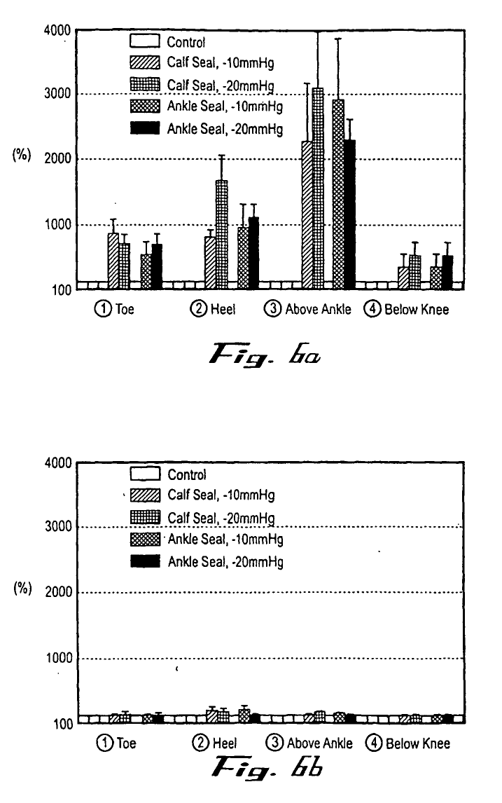

The right lower legs of eight healthy male subjects, aged 22-35 years, were used. Subjects were seated and laser Doppler probes were placed at the locations indicated in FIG. 5: 1) the dorsum of the foot, 2) the medial heel, 3) the narrowest part of the ankle anterior to tibia, and 4) 5 cm below of lower edge of the kneecap. The test leg was placed in a chamber that was connected to a vacuum source and a pressure gauge. The loose seal according to the present invention was used to generate negative chamber pressure. The seal was tested at two different heights: the lower edge of the calf, above the ankle, and the maximum circumference of the calf below the knee. After a stabilization period, a test with normal, ambient pressure provided baseline control data. The chamber pressure was set at environmental pressures of −10 and −20 mmHg for each height of the loose seal. The leg was exposed to each environmental pressure for five minutes, and the chamber was returned to normal atmospheric pressure until baseline values of blood flow were restored. After the loose seal condition, the seal was tightened against the leg, and the same procedures were performed. Data were normalized so that skin blood flow at normal ambient pressure was defined as 100%. Data points were generated by averaging the instantaneous signals over 10-second periods.

All data were expressed as means±SE and were analyzed by repeated measure ANOVA. If statistically significant effects were found, a post-hoc test was applied to compare conditions. Significance was set at p<0.05.

FIG. 6a provides a plot of skin blood flow during −10 and −20 mmHg exposures with a loose seal set at maximum girth of the calf (higher seal) and at the lower aspect of the calf (lower seal). Skin blood flows at all of the measurement sites 1-4 indicated in FIG. 5 were significantly increased compared to those at normal ambient pressure (normalized to 100%). Blood flow on the foot dorsum and heel increased 7- to 17-fold during −10 and −20 mmHg with both the higher and lower loose seals compared to those at normal ambient pressure. Blood flow increased from 7 to 30 times normal at the ankle for both loose seal positions compared to that at normal ambient pressure. (*p<0.05 compared to control value.). Outside of the chamber (site 4), blood flow changes were slightly higher than those at normal ambient pressure. No significant differences were observed between the higher seal and lower seal conditions.

As can be seen from the results plotted in FIG. 6b, with a tight seal, skin blood flow showed little or no change relative to normal ambient pressure at all measurement points.

### EXAMPLE 2

### Lower Leg of Diabetes Mellitus Patient

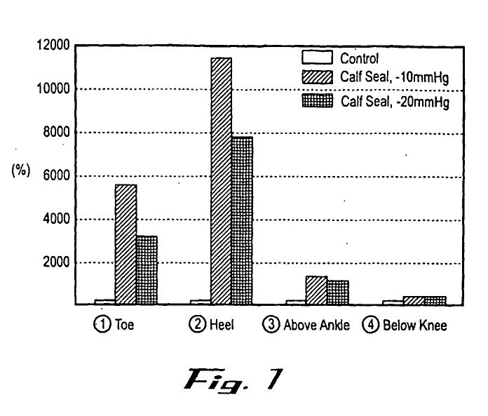

The lower right leg of a diabetes mellitus patient (60 years old with mild Type 2 DM) was treated using similar test protocols and conditions as those described for Example 1 except that only the loose calf seal (upper seal as indicated in FIG. 5) was used. The normalized skin microvascular flow results are plotted in FIG. 7, with increases ranging from about 18 to 15 times those of the control value at the three points within the chamber for −10 mmHg. Increases produced by a negative pressure of −20 mmHg provided improvement over normal ambient pressure, from 14 to 78 times greater flow. At both mild negative pressures, the greatest improvement is seen at the heel (site 2), a common location for foot ulcers in diabetic patients, indicating that the present invention should be highly effective in promoting healing of such ulcers. Further, the present invention may be utilized as part of an on-going therapy program to prevent or minimize occurrence of future ulcers in diabetic patients who have a history of impaired microcirculation and chronic ulcers.

### EXAMPLE 3

### Hand

In this example, the hypobaric chamber with non-occlusive seal according to the present invention was used in an evaluation of the effectiveness of a mechanical counter-pressure (MCP) space suit glove to simulate a low pressure environment such as would be encountered during extra-vehicular activity (EVA) during space flight. A description of this MCP glove is provided in U.S. Patent Application Publication No. US 2002/0116744, which disclosure is incorporated herein by reference. The right hands of 8 healthy, non-smoking male subjects, aged 22-34 years, were used. Volunteers were screened to exclude those with any past history of systemic disease or injury or surgery to their right hand.

Tests were run at negative chamber pressures of −50, −100 and −150 mmHg. In order to achieve the lower chamber pressures (−100, −150 mmHg), it was necessary to tighten the seal around the subject's wrist.

A 2.5 mm thick laser Doppler probe was placed at the dorsum of the hand and connected to a laser Doppler flowmeter (LASERFLO BPM403A, VASAMEDICS, St. Paul, Minn.) to measure skin blood flow. Skin temperature was recorded by a YSI 400 series thermistor placed near the laser Doppler probe. Volume changes of the middle finger were recorded with a mercury strain gauge plethysmograph (EC6 plethysmograph, Hokanson, Bellevue, Wash.). Arterial blood pressure and pulse rate were measured continuously at the left middle finger by a continuous blood pressure monitor (2300 Finapress, Ohmeda, Louisville, Co.). All measurements were monitored and recorded continuously using an A-D converter with a programming software (Lab View 5.0.1, National Instruments, Austin, Tex.) at a rate of 50 samples/s. Subjects were in sitting position throughout the study. Test hands were placed in a clear plastic chamber that was connected to a vacuum source and a pressure gauge. Both hands were positioned on an arm rest at heart level. After a stabilization period, a test with normal, ambient pressure (control) without the glove was performed to record baseline data. The chamber pressure was set from smaller to larger pressure differentials at the measuring site (ΔP), i.e., −50 mmHg without glove (ΔP=−50 mmHg), −150 mmHg with glove (ΔP=+50 mmHg), −100 mmHg without glove (ΔP=−100 mmHg), −100 mmHg with glove (ΔP=+100 mmHg), −50 mmHg with glove (ΔP=150 mmHg), and −150 mmHg without glove (ΔP=−150 mmHg) in order to return to baselines conditions more rapidly and to reduce additive effects of repeated negative or positive pressures. In the condition without any glove, the skin of the hand was directly exposed to the negative pressures. This test sequence also minimized any risk of injury to the volunteers. Right hands were exposed to each environmental pressure for five minutes, and the chamber was returned to normal atmospheric pressure until baseline values of blood flow were restored between each environmental pressure condition. For data normalization, baseline arterial blood pressure, pulse rate, and skin microvascular blood flow at the normal ambient pressure test were defined as 100%. Also, finger girth was set as zero percent just before each session and showed percentage changes from the normal ambient pressure condition. Skin temperature was measured in degrees Celsius and changes from that at normal ambient pressure condition were reported. Data points were generated by averaging the instantaneous signals over 10-second periods. The averaged value of 20 seconds at each site was used for data of each condition.

All data were expressed as means±SE, and were analyzed by repeated measure ANOVA. If statistically significant effects were found, Fisher's post-hoc test was applied to compare between conditions. Significance was set at p<0.5.

All subjects completed the entire protocol although they felt greater discomfort with higher levels of negative chamber pressure. It is believed that this discomfort was caused by the tighter seal around the wrist that was required when using greater negative pressure. This discomfort was deemed an artifact of the seal because it was located at the wrist only. It disappeared immediately after each exposure, and no adverse symptoms or signs (except redness of the skin) were observed after the entire protocol.

Without the MCP glove, mean arterial blood pressure significantly increased with negative pressure (110.2±4.8, 120.0±3.8, 129.2±6.5% at −50, −100, −150 mmHg, respectively), compared to that of normal ambient pressure (range 71.2-100 mmHg). The blood pressure with the MCP glove was also increased (120.2±4.5, 125.4±8.1, 123.0±8.7%), but there were no significant differences between measurements with and without the MCP glove. Pulse rate did not change significantly (106.4±3.6, 103.7±4.9, 101.4±4.9% without the glove versus 105.7±7.3, 100.6±5.8, 104.0±6.7% with the glove at −50, −100, −150 mmHg, respectively), compared to that of normal ambient pressure (range 45.2-87.2 beats per minute).

Without the MCP glove, skin blood flow at the dorsum of the hand significantly increased at −50 mmHg (2441.5±447.3%), and gradually decreased at −100 mmHg (1680.1±362.6%) and −150 mmHg (1578.8±204.9%), compared to that of normal ambient pressure (range 0.40-1.31 arbitrary units). The decrease in blood flow at the higher negative pressures (−100, −150 mmHg) reflects the effect of the tighter seals required to maintain the lower pressures. Due to the increase in blood flow, the middle finger girth increased at −50, −100, −150 mmHg (1.0±0.5, 2.28±0.7, 3.1±0.7%, respectively). In spite of increase in regional blood flow and finger girth, skin temperature significantly decreased with negative pressure (−4.9±0.43, −3.8±0.4, −2.8±0.6° C. at −50, −100, −150 mmHg, respectively) compared to that of normal ambient pressure (range 30.9-35.1° C.).

The testing described in this example illustrates the advantageous use of mild negative pressure and the non-occlusive seal in enhancing microvascular blood flow 30 relative to the higher negative pressures and tight seals of prior art methods.

The device and method of the present invention employ locally applied negative pressure and an adjustable loose seal to enhance microvascular blood flow while avoiding venous stasis. This hypobaric technique is pertinent to any ailment which would benefit from increased blood flow to and from a local body part with the corresponding increase in oxygen and nutrient supply. Further, the inventive device and method assist in metabolic end product removal from a body part. An important application is the treatment of poor circulation like diabetic or atherosclerotic ulcers in the extremities, particularly the lower extremities.

It will be evident that there are additional embodiments which are not illustrated above but which are clearly within the scope and spirit of the present invention. The above description and drawings are therefore intended to be exemplary only and the scope of the invention is to be limited solely by the appended claims.

What is claimed is:

1. A method for enhancing blood flow in a body part of a patient, the method comprising:
inserting the body part through a port in a hypobaric chamber;
forming a non-occlusive seal at the port around the body part so that the seal does not contact the body part;
creating a mild negative pressure within the chamber relative to an ambient pressure; and
exposing the body part to the mild negative pressure for a pre-determined period.

2. The method of claim 1, wherein the non-occlusive seal comprises an adjustable iris comprising a pliable elastic material having an outer edge and a center opening with a center edge, wherein the outer edge is attached to the port and a plurality of radially-adjustable slides is attached to the center edge so that the pliable elastic material is stretched between the port and the slides.

3. The method of claim 2, wherein the pliable elastic material is latex or a similar rubber-like material.

4. The method of claim 2, wherein each of the plurality of slides includes means for locking the slide in place after adjustment.

5. The method of claim 1, wherein the mild negative pressure is less than 50 mmHg.

6. The method of claim 5, wherein the mild negative pressure is within the range of −10 to −20 mmHg.

7. The method of claim 1, wherein the body part is a foot or lower leg.

8. The method of claim 7, wherein the patient is diabetic.

9. The method of claim 1, wherein the body part is a hand or forearm.

10. The method of claim 1, wherein the pre-determined period comprises a pre determined length of time.

11. The method of claim 1, wherein the pre-determined period comprises a length of time required to reach a pre-determined value of a parameter.

12. A device for enhancing blood flow in a body part of a patient, the device comprising:
a hypobaric chamber;
a port formed in the chamber through which the body part may be inserted into the chamber;
an adjustable aperture disposed within the port for encircling the body part at the point of entry into the chamber to create a non-occlusive seal;
a vacuum source for generating a mild negative pressure within the chamber; and
vacuum tubing for connecting the vacuum source to the chamber.

13. The device as in claim 12, wherein the adjustable aperture comprises an iris comprising a pliable elastic material having an outer edge and a center opening with a center edge, wherein the outer edge is attached to the port and a plurality of radially-adjustable slides is attached to the center edge so that the pliable elastic material is stretched between the port and the slides.

14. The device as in claim 13, wherein the pliable material is latex or rubber-like material.

15. The device as in claim 12, wherein the mild negative pressure is less than ambient pressure and higher than −50 mmHg.

16. The device as in claim 15, wherein the mild negative pressure is in the range of −10 to −20 mmHg.

17. A method for treatment of impaired microcirculation in a diabetic patient, the method comprising:
inserting an affected limb through a port in a hypobaric chamber;
adjusting a non-occlusive seal around the limb;
creating a mild negative pressure within the chamber relative to ambient, wherein the mild negative pressure is less than −50 mmHg; and
exposing the limb to the mild negative pressure for a pre-determined period.

18. The method of claim 17, wherein the non-occlusive seal comprises an iris comprising a pliable elastic material having an outer edge and a center opening with a center edge, wherein the outer edge is attached to the port and a plurality of radially-adjustable slides is attached to the center edge so that the pliable elastic material is stretched between the port and the slides.

19. The method of claim 17, wherein the mild negative pressure is −10 mmHg.

20. The method of claim 17, wherein the affected limb is a lower leg and the non-occlusive seal is disposed around the patient's upper calf.

21. The method of claim 17, wherein the pre-determined period comprises a pre-determined length of time.

22. The method of claim 17, wherein the pre-determined period comprises a length of time required to reach a pre-determined value of a parameter.
